(19) United States
(12) Patent Application Publication
(10) Pub. No.: US 2003/0125965 A1
(43) Pub. Date: Jul. 3, 2003

(54) Method and system for managing contractual risk

(76) Inventors: Edward D. Falso, Marietta, GA (US); Jeffrey L. Hays, Atlanta, GA (US); William Alan Marriott, Smyrna, GA (US); Jeffrey A. Whittingham, Kennesaw, GA (US)

Correspondence Address: PERKINS COIE LLP, PATENT-SEA, P.O. BOX 1247, SEATTLE, WA, 98111-1247, US

(21) Appl. No.: 10/032,209

(22) Filed: Dec. 21, 2001

(51) Int. Cl. G06F 17/60

(52) U.S. Cl. 705/1

(57) ABSTRACT

A method and system for assessing and managing risk associated with a contract. The system allows a business to establish its risk profile/parameters/guidelines for contracts. The contract risk management system receives information relating to a particular proposed contract, which may include one or more risk variations or variations to a standard form of contract. The system identifies an approver for a variation and coordinates reception of approval of the variation by the identified approver. When all approvals have been received, the system indicates approval of the contract. The system may also generate a risk report based on the risk factors and premises associated with the contract and the current status of approvals for that contract.

### BACKGROUND OF THE INVENTION

The described technology relates generally to analysis of contractual terms and particularly to a computer system that manages the identification, tracking, and approval of high-risk contractual terms.

Many companies and their customers use very detailed written contracts to specify the terms of their agreements to provide products or services. These contracts often need to be tailored to meet the specific needs of the customer. Large companies may have thousands of customers each with multiple contracts relating to various products and services that are provided by that company to the customer. A company, of course, wants to ensure that the terms of the contract do not expose the company to unnecessarily high risks. For example, a customer may propose a delivery date of six months after the contract is executed and propose that the company pay significant penalties for delayed delivery. The company's representative who is negotiating with the customer may not realize that, based on recent experience, a six-month delivery period is unrealistic. If the company were to agree to the proposed term, then the company would likely incur the significant penalties.

To minimize the chances of entering into contracts with such high-risk terms, companies often have a contract review process that allows for a risk assessment to be made before each contract is executed. A company typically has a risk assessment team whose job it is to meet periodically and assess the risks associated with each contract. Before the risk assessment team meets, several reports may be manually generated by risk assessment analysts who try to point out the high-risk terms associated with each contract. The company may have a risk assessment analyst for each possible risk type. For example, a company may have both a financial risk assessment analyst whose job it is to identify whether the financial terms present a high risk and a choice of law risk assessment analyst whose job it is to identify whether the choice of law in a particular venue presents a high risk. The risk assessment analyst may also suggest ways in which the terms of the contract can be modified to reduce the risk. In some cases, multiple risk assessment analysts are required to approve a particular variation. When the risk assessment team meets, it analyzes the various risk assessment reports and determines whether the contract is acceptable, acceptable with modifications, or unacceptable. The majority of the proposed contracts may use only standard contractual terms and thus are acceptable. The risk assessment team may, however, devote a significant amount of time deciding whether such proposed contracts are acceptable. In addition, each risk assessment analyst may apply different standards when assessing the risk of a term, may present their report in a very different format, may suggest very different modifications to the proposed contracts, and so on. Because of this lack of uniformity and because the reports are generated manually, it is difficult and time-consuming to assess the risk of proposed contracts.

In addition, because sometimes anyone from a team of risk assessment analysts could approve a term, it is also sometimes difficult to track which risk assessment analyst gave the approval for a term and when they did so. Moreover, training new risk assessment analysts is often done manually and is therefore time-consuming and on an ad hoc basis, resulting in inefficient and sometimes inconsistent training.

It would be desirable to have a risk assessment system that would help automate the process of assessing the risk of proposed contracts and projects in general, would provide uniformity in risk assessment, and would help speed up the process of risk assessment.

### BRIEF DESCRIPTION OF THE DRAWINGS

FIG. 1 is a display page used to collect information about a proposed contract in one embodiment.

FIG. 2 is a display page used to collect information about risk factors associated with a particular proposed contract in one embodiment.

FIG. 3 is a display page used to collect information about a proposed contract and about approval of high-risk terms of the proposed contract in one embodiment.

FIG. 4 is a display page used to collect information about the person responsible for a proposed contract in one embodiment.

FIG. 5 is a display page illustrating a sample risk report for a proposed contract in one embodiment.

FIG. 6 is a block diagram that illustrates components of the contractual risk management system in one embodiment.

FIG. 7 illustrates a database schema for the contractual risk management system in one embodiment.

FIG. 8 is flow diagram illustrating a request to input a proposed contract in one embodiment.

FIG. 9 is a flow diagram illustrating the processing of a request to input a proposed contract in one embodiment.

FIG. 10 is a flow diagram illustrating a request for a contractual risk report in one embodiment.

FIG. 11 is a flow diagram illustrating the processing of the generate report component in one embodiment.

FIG. 12 is a flow diagram illustrating an approval of a variation of a proposed contract in one embodiment.

FIG. 13 is a flow diagram illustrating the processing of an approval of a variation of a proposed contract in one embodiment.

### DETAILED DESCRIPTION

A method and system for managing risk factors associated with a contract is provided. In one embodiment, the system receives information related to a contract. The contract information includes an indication of one or more variations to the contract. The system identifies an approver for each of the risk variations identified in the contract or one or more variations from a standard form of contract. The approver may be an individual or a group of individuals. The system then coordinates reception of approvals of the variation by the identified approver or approvers. When all approvals have been received, the system indicates approval of the contract.

The system incorporates an identification of risks and contract risk standards as established by the company for a specified type of contract. The system then identifies variations from such standards in a particular contract. Alternatively, the system identifies variations from a standard form of contract established by the company.

In another embodiment, the sytem stores the contract information and identifies one or more risk factors associated with each variation. The system may then identify one or more premises associated with each risk factor. Upon receiving a request for a risk report, the system may generate a risk report, which may include at least part of the contract information and an indication of the risk factors and premises associated with the contract and its variations. After generating the risk report, the risk report may be transmitted to a user.

Variations to a contract will often result in triggering one or more risk factors. The risk factors identify certain aspects (e.g., high-risk terms) of a contract that might provide undue risk to the company executing the contract. Table 1 illustrates a risk factor table with associated premises. The table contains an entry for a wide variety of risk factors and a short description of those risk factors. Table 1 also contains sample premises that are associated with each risk factor. Premises are pre-defined ways in which a risk factor could be triggered. For example, risk factor number seven is “Governing Law,” which is the governing law for the contract, and sample premises are governing law in other states, governing law outside the United States, and governing law outside common law countries. These premises would differ from the standard contract term of, say, the laws of the state of New York. One skilled in the art will recognize that many risk factors and premises exist and are within the scope of the invention.

TABLE 1
Risk Factors

| # | Risk Factor | Description | Sample Premises |
|---|---|---|---|
| 1 | Application of | Ability to use new | Customer approval required |
| | Technology | technology in | No substitution |
| | | performance | |
| | | of agreement | |
| 2 | Contracted | Performance | Liquidated damages not |
| | Performance | guarantees | sole remedy |
| | | | Performance guarantee < |
| | | | 10% down |
| 3 | Contracting | Selection of | Internal consortium |
| | Entities | contractor and | Independent contractor |
| | | deal structure | |
| 4 | Contractor | Shall not | Increased Contractor |
| | Responsibility | be more than | Responsibilities |
| | | specified in | |
| | | standard contract | |
| 5 | Dispute | Dispute resolution | Arbitration |
| | Resolution | mechanism, forum, | Outside U.S. |
| | | and venue | Outside Europe |
| 6 | Excusable Delay | No liability to | Strikes |
| | | extented perfor- | Wording Variation |
| | | mance prevent | |
| | | by excusable delay | |
| 7 | Governing Law | Governing law | Other states |
| | | for the | Outside U.S. |
| | | contract | Outside common law |
| | | | countries |
| 8 | Indemnity | Hold harmless | Any other act/omission |
| | | provision | Customer property |
| | | | Wording deviation |
| 9 | Inventory | Ability to substitute | Limitation on right |
| | | refurbished and | No right |
| | | third-party parts | |
| 10 | Limitations on | Carveouts for | Carveout for injury |
| | Liability | potential | Carveout for punitive |
| | | damages | damages |
| | | | Monetary Caps |
| 11 | Model Variances | Deviations | Model deviations |
| | | from standard | |
| | | model output | |
| 12 | Other | Other deviations | Other deviations |
| 13 | Owner | Details customer | Permits and licenses |
| | Responsibility | responsibilities | Other |
| 14 | Payment | Security and | Payment in other than U.S. |
| | | currency | currency |
| | | | Payment security |
| 15 | Payment | Structure of | Quarterly payments |
| | Structure | payments | Escalation clauses |
| 16 | Performance | Customer | Inventory data |
| | Data | must provide | Performance data |
| | | information on parts | |
| 17 | Precommis- | Initial factored | Precommissioning hours |
| | sioning | fire hour | |
| | Hours | computation | |
| 18 | Safety | Safety issues | Hazards review |
| | | | Hazardous waste disposal |
| | | | Pre-existing conditions |
| 19 | Termination | Ability to control | Buy-out |
| | Provisions | termination | After a certain date |
| 20 | Title transfer & | Title transfer | Consistent delivery |
| | delivery | & delivery | Parts |
| 21 | Total Price | Greater than a | Greater than a certain |
| | | certain amount | amount |
| 22 | Unplanned | Cap on responsi- | Cap greater than a certain |
| | Maintenance | bility for unplanned | amount |
| | | maintenance | |
| 23 | New/Atypical | Work that is new or | New parts or software |
| | Activity | atypical for the | New environmental issues |
| | | organization | |
| 24 | Warranty | Warranty | Exclusive remedy |
| | | information | Duration greater than a |
| | | | certain time |
| | | | Other warranties |

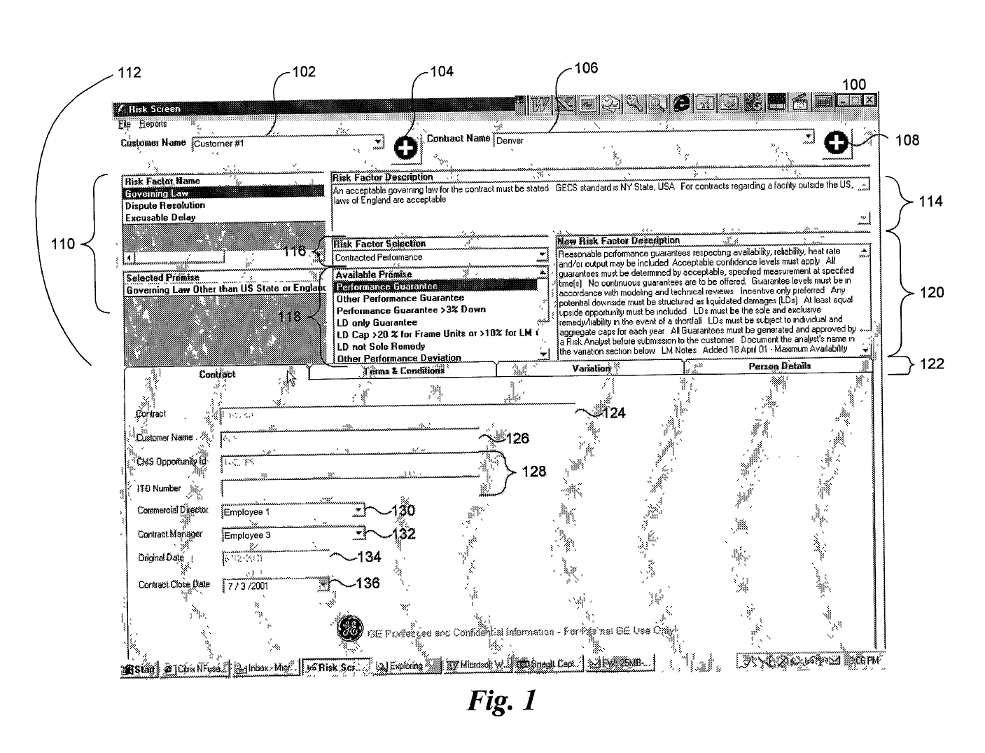

FIGS. 1-4 illustrate sample display pages of a contractual risk management system in one embodiment. FIG. 1 is a display page used to collect general information describing a proposed contract and its proposed variations. The example contract relates to providing services for power generation equipment, such as gas and steam turbines. One skilled in the art will, however, appreciate that the contractual risk management system can be used to manage the risks associated with contracts in virtually any industry or profession, including contracts for both goods and services. The display page 100 includes selection tabs 122. The selection tabs allow the user to choose the functionality of the display page by selection either the contract tab, the terms & conditions tab, the variation tab, and the person details tab. When a user selects a selection tab, the contractual risk management system displays a display page through which the user can enter data relating to the type of tab selected. In the embodiment illustrated in FIG. 1, the contract tab is selected, allowing the user to enter data relating to the proposed contract.

Display page 100 includes a customer name field 102, an add customer button 104, a contract name field 106, and an add contract button 108. The customer name field is a drop-down list that allows the user to select a customer from a list of customers in the contractual risk management system. The add customer button will activate an add customer page or dialog box that allows the user to input a new customer into the contractual risk management system if the desired customer is not found in the customer name field. The contract name field is a drop-down list that allows the user to select a contract from a list of contracts in the contractual risk management system. In one embodiment, the contract name field lists proposed and/or existing contracts with the customer identified in the customer name field. The add contract button will activate an add contract page or dialog box that allows the user to input a new contract into the contractual risk management system if the desired contract is not found in the contract name field. In an alternative embodiment, new contracts and new customers may be automatically entered into the contractual risk management system from another system without need for manual input by a user.

Display page 100 also includes a risk factor name box 110, a selected premise box 112, a risk factor description box 114, a risk factor selection field 116, an available premise box 118, and a new risk factor description box 120. The risk factor name box lists risk factors associated with variations that have been proposed for the contract selected in the contract name field. For example, in display page 100 the risk factors associated with the proposed contract variations are governing law, dispute resolution, and excusable delay. The selected premise box displays the selected premises associated with the risk factor selected or highlighted in the risk factor name box. In one embodiment, one risk factor is highlighted in the risk factor name box, and all of the premises that have been selected by a user related to that risk factor are displayed in the selected premise box. The risk factor description box includes descriptive information concerning the contracting standards of the company and the risk factor selected in the risk factor name box, and may also include information about any premises selected for that risk factor as displayed in the selected premise box. The risk factor selection field, the available premise box, and the new risk factor description box assist a user in selecting new risk factors and premises for the selected contract. The risk factor selection field allows a user to select a new risk factor from a drop-down list. The available premise box displays all of the available premises for the risk factor selected using the drop-down list of the risk factor selection field, and also allows the user to select one or more of the available premises. The new risk factor description box displays information about the selected risk factor and/or the selected available premise. The displayed information explains the justication for a particular risk factor and/or premise and the contracting standards for the company related to the justification, and also improves the training process for new employees.

Display page 100 also includes a contract name field 124, a customer name field 126, identification number fields 128, a director field 130, a contract manager field 132, an original date field 134, and a close date field 136. The contract name field allows a user to input a name for the contract, while the customer name field allows a user to input the name of the other contracting party or customer. The identification number fields, in one embodiment, provide for a unique identification number or numbers for a contract. The director field and the contract manager field are drop-down lists that allow a user to select the names of a person or persons who have responsibility for the identified contract. In the depicted embodiment, the contract manager indicates the person with primary responsibility for the contract and the director field indicates the person with the business responsibility for the contract negotiation. The original date field includes the date that the contract approval process was initiated in the contractual risk management system. The close date field is a drop-down list that allows a user to select a close date for the contract, which is the date which the contract is intended to be signed, providing the worst-case deadline for receiving approvals from all necessary parties.

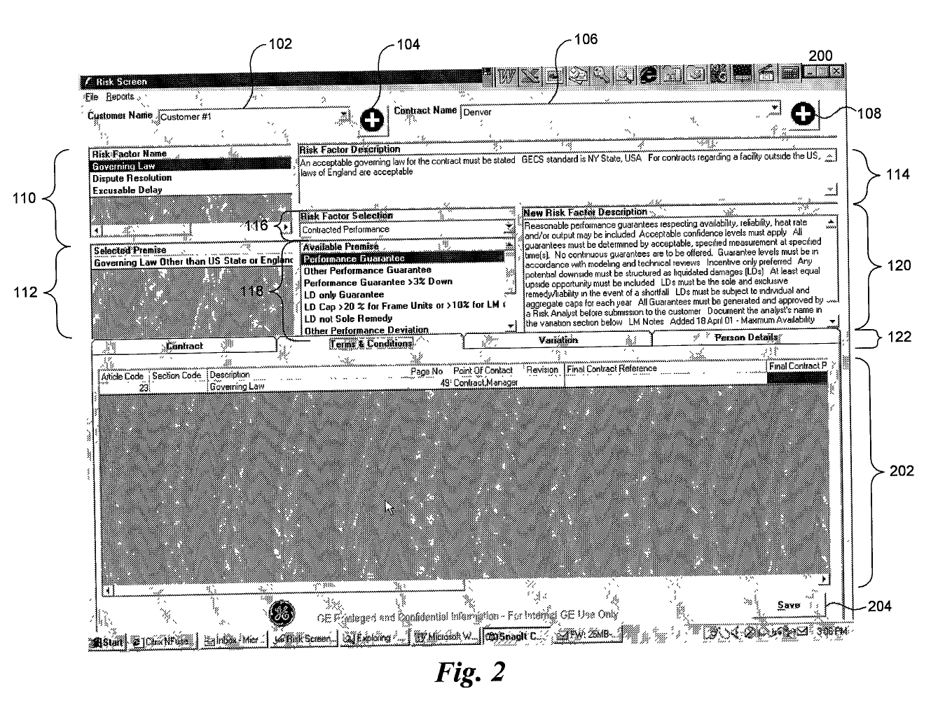

FIG. 2 is a display page used to collect information about risk factors associated with a particular proposed contract in one embodiment. Display page 200 is activated when a user selects the terms & conditions tab of the selection tab. Display page 200 includes selection tabs 122, a customer name field 102, an add customer button 104, a contract name field 106, an add contract button 108, a risk factor name box 110, a selected premise box 112, a risk factor description box 114, a risk factor selection field 116, an available premise box 118, and a new risk factor description box 120. The operation of these tabs, fields, and boxes is substantially similar to the operation of the similarly named tabs, fields, and boxes described in relation to FIG. 1.

FIG. 2 also includes a selected risk factor box 202 and a save button 204. The selected risk factor box provides a description and other information of the risk factor currently highlighted in the risk factor name box. In an alternative embodiment, the selected risk factor box instead lists all of the selected risk factors for the proposed contract and shown in the risk factor name box. The selected risk factor box includes an article column, a section column, a description column, a page number column, a point of contact column, a revision column, and a final reference column. The article column and the section column identify the location in the proposed contract where the variation is located so that the text of the variation can easily be found. The description column includes the name of the risk factor associated with the variation, and the page number further identifies the location of the variation in the proposed contract. The revision column identifies the latest revision of the proposed contract, and the final reference column specifies the location of the approved variation in the final version of the contract. The save button 204 allows a user to save all of the risk factors, premises, user information, and other information that has been inputted upon selection of the save button.

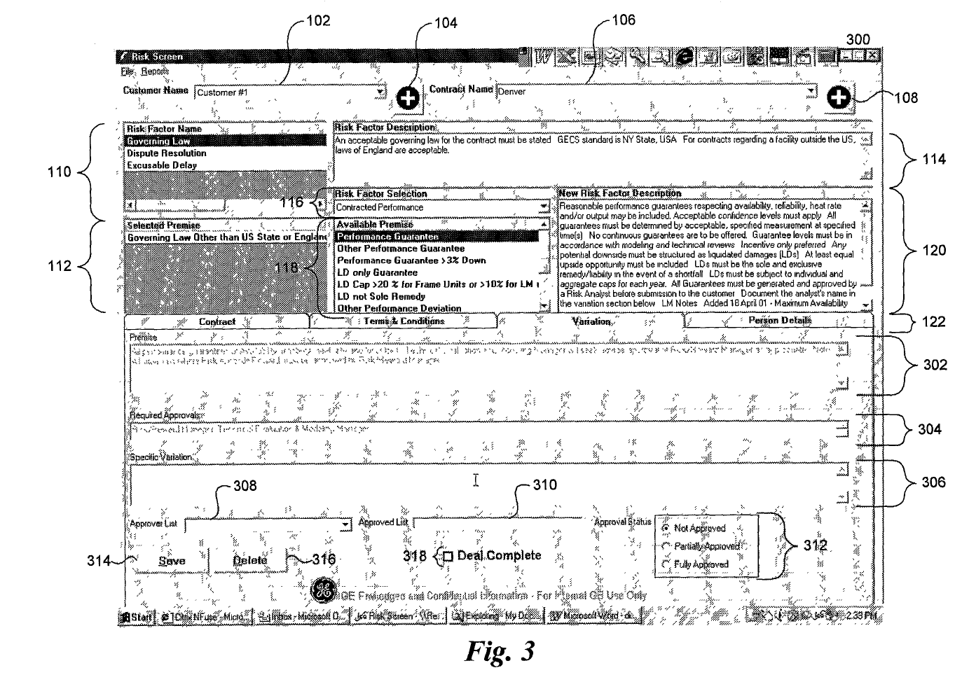

FIG. 3 is a display page used to collect information about a proposed contract and about approval of high-risk terms of the proposed contract in one embodiment. Display page 300 is activated when a user selects the variation tab of the selection tab. Display page 300 includes selection tabs 122, a customer name field 102, an add customer button 104, a contract name field 106, an add contract button 108, a risk factor name box 110, a selected premise box 112, a risk factor description box 114, a risk factor selection field 116, an available premise box 118, and a new risk factor description box 120. The operation of these tabs, fields, and boxes is substantially similar to the operation of the similarly named tabs, fields, and boxes described in relation to FIG. 1.

FIG. 3 also includes a premise box 302, a required approvals box 304, and a specific variation box 306. The premise box provides a description of the premise highlighted in the available premise box. Similarly to the function of the risk factor description box, this allows the user to understand the reasons underying the premise to improve understanding of the premise and training of new employees. The required approvals box identifies all of the individuals or organizations that must approve the variation identified by the selected premise. In the depicted embodiment, for example, the Risk/Reward manager and the Technical Evaluation & Modeling Manager must both approve the variation of the contract. The specific variation box allows users to input the exact variation to the contract that has been proposed. For example, the premise could be identified as governing law outside the United States, and the specific variation could be Japanese law.

In one embodiment, the user could select a new available premise by “double-clicking” or otherwise selecting the premise highlighted in the available premise box. This would cause the highlighted premise to appear in the selected premises box, and the risk factor associated with that premise would appear in the risk factor name box. This process allows a user to increase the number of premises and risk factors associated with proposed changes in the standard contract.

FIG. 3 additionally includes an approver list 308, an approved list 310, an approval status indicator 312, a save button 314, a delete button 316, and a deal complete indicator 318. The approver list is a drop-down list of all of the individuals or organizations that are required to approve the selected variation to the contract in order to complete the contract. The approved list is a drop-down list of all of the individuals or organizations that have already given approval of the selected variation to the contract. The approval status indicator provides an indication of not approved, partially approved, or fully approved. If no approvals have been received an indication of not approved will be used, if some but not approvals have been received an indication of partially approvied will be used, and if all approvals have been received an indication of fully approved will be used. Accordingly, the approval status indicator may be used to view the current status of the selected premise in a rough fashion. The save button is used to save any changes made to display page 300. To approve a variation, an authorized individual would select the appropriate option of the approver list (e.g., their name or position) and then select the save button. The delete button may be used to delete a premise highlighted in the selected premise box. This allows proposed changes to the contact to be removed by a user. Once the last premise associated with a risk factor has been deleted, the risk factor is also deleted from the risk factor name box. The deal complete indicator is activated when all required approvals have been received and the contract is therefore ready for signature.

In an alternative embodiment, conditional approvals may be used. By adding language to the specific variation box 306, an approver may condition an approval upon certain deletions, additions, or other changes to the contract. This provides another way of streamlining the approval process, as an approver may not need to repeatedly review a proposed contract.

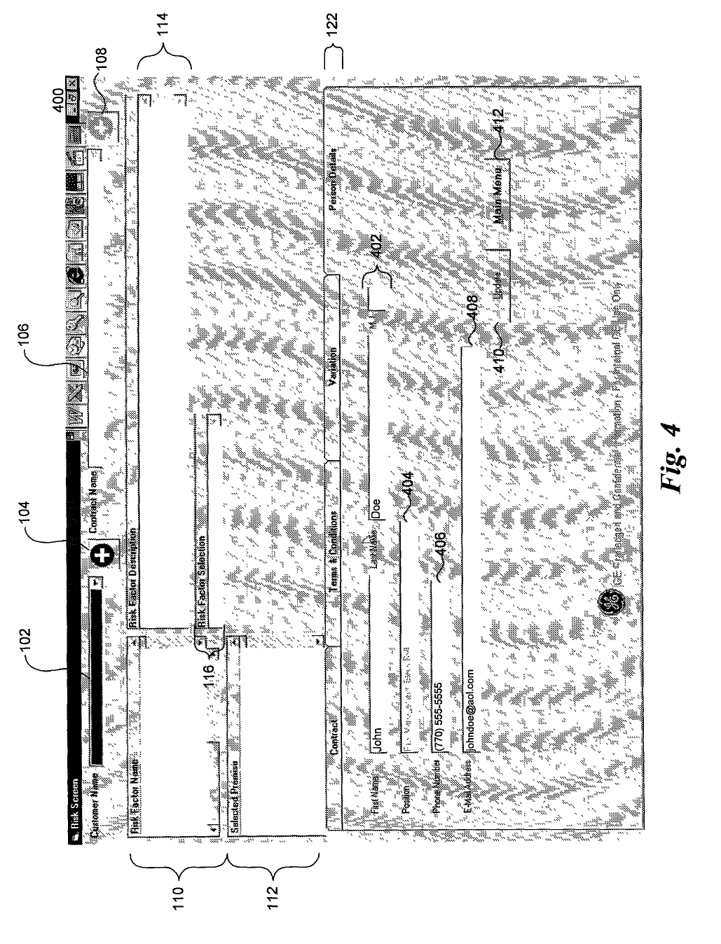

FIG. 4 is a display page used to collect information about the person responsible for a proposed contract in one embodiment. Display page 400 is activated when a user selects the person details tab of the selection tab. Display page 400 includes selection tabs 122, a customer name field 102, an add customer button 104, a contract name field 106, an add contract button 108, a risk factor name box 110, a selected premise box 112, a risk factor description box 114, and a risk factor selection field 116. The operation of these tabs, fields, and boxes is substantially similar to the operation of the similarly named tabs, fields, and boxes described in relation to FIG. 1.

FIG. 4 also includes name fields 402, a position field 404, a phone number field 406, e-mail field 408, an update button 410, and a main menu button 412. The name fields and the position field are used to identify the name and organizational position, respectively, of the person with responsibility for the selected contract. The phone number field and the e-mail field provide contact information for the person identified in the name fields. The update button may be used to save any changes made to the information entered or any new information entered on display page 400, and the main menu button returns the user to a main menu page without saving any information entered or changed on display page 400.

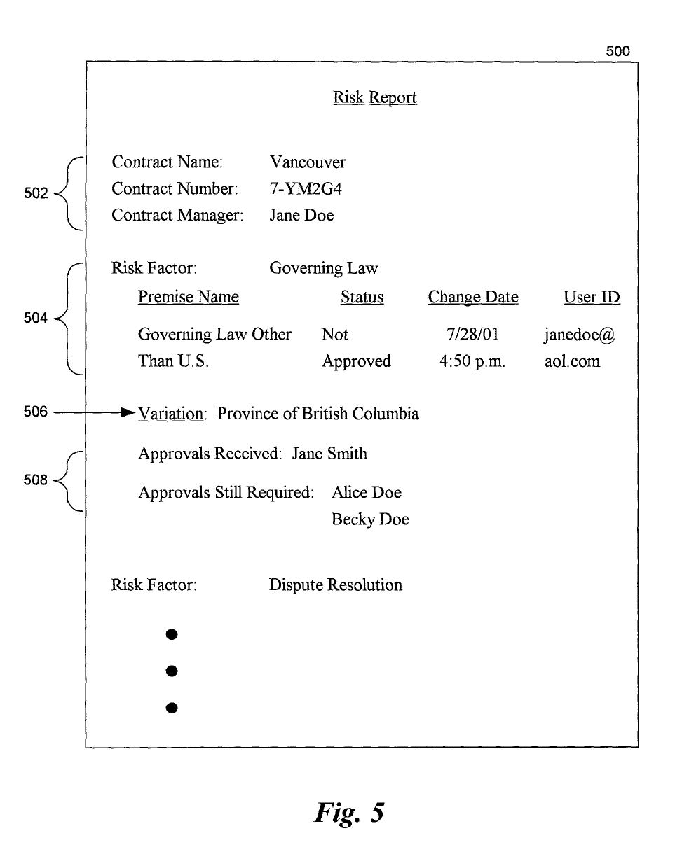

FIG. 5 is a display page illustrating a sample risk report for a proposed contract in one embodiment. This report provides a summary of the contract, the proposed variations to the contract and the risk factors and premises associated with each variation, and the status of each required approval. A display page 500 includes a contract information section 502, a risk factor section 504, a variation section 506, and an approval section 508. The contract information section provides information about the contract that is the subject of the risk report, such as the contract name, unique contract number, customer name, contract manager, etc. The risk factor section provides information about one or more risk factors associated with proposed variations in the contract, and also provides information about one or more premises associated with each risk factor. This includes information about the current status of the proposed variation (e.g., not approved), the date that the information changed, and the identification of the person making the change. This allows the progress of a contract over time to be tracked, in addition to tracking the identity of the individuals approving a variation, changing information, etc. This information creates a persistent, auditable trail of the approvals required and obtained for each contract signed. The variation section includes the specific variation proposed for the contract. The approval section includes information about which required approvers have already given approval and which required approvers still have not given approval.

The risk report of display page 500 provides a quick summary of the current status of a proposed contract, and in particular highlights the provisions of the contract that still need to be approved. The risk report of display page 500 also provides a history of the approval of a contract, identifying the persons who approved variations and when they made such approvals. These reports may be used by a risk assessment team or management to track the progress of a contract, the response times of individual personnel, or other aspects of the contract approval process. One skilled in the art will recognize that many types of reports are possible and within the scope of the invention. For example, any type of metrics report may be created, such as for tracking the length of time to receive each approval, comparing the contract approval process for different technologies, geographic regions, or approvers, etc. Additionally, any type of summary report may be created, such as reports that indicate which contracts include a particular variation, risk factor, or premise, reports that summarize contracts approved over a certain timeframe, etc.

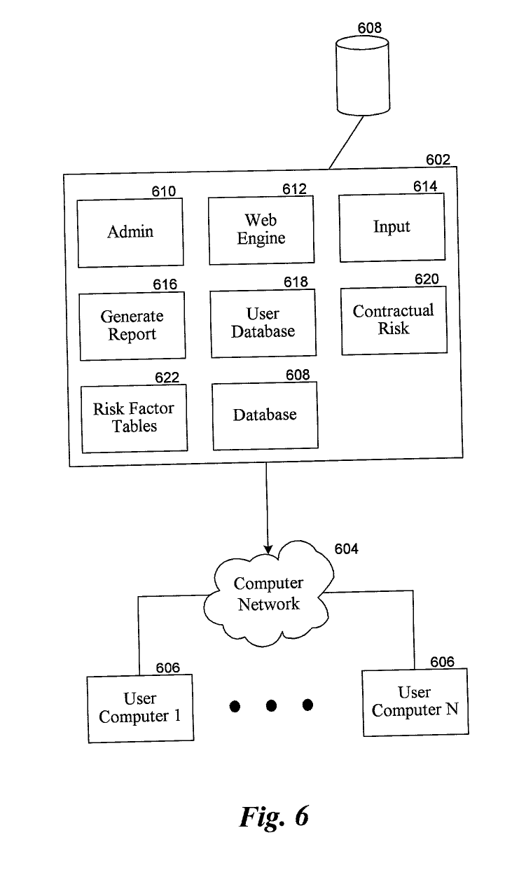

FIG. 6 is a block diagram that illustrates components used to implement the contractual risk management system in one embodiment. The risk management server 602 and one or more user computers 606 are interconnected via a computer network 604, such as the Internet or an intranet. A database 608 may be in communication with the risk management server, or alternatively may be located within the risk management server. The computers may include a central processing unit, memory, input devices (e.g., keyboard and pointing device), output devices (e.g., display devices), and storage devices (e.g., a hard drive, a CD-ROM, a floppy disk drive, etc.). The memory and storage devices are computer-readable media that may contain instructions for implementing the contractual risk management system. In addition, the data structures and message structures may be stored or transmitted via a data transmission medium, such as a signal on a communications link. Various communications channels may be used, such as a local area network, wide area network, or a point-to-point dial-up connection can be used. One skilled in the art will appreciate that the contractual risk management system can be implemented in other environments (in addition to the client/server environment) such as a single machine in which the contractual risk management software executes on a computer and accesses a database on the same computer.

The risk management server includes an admin component 610, a web engine 612, an input component 614, a generate report component 616, a user database 618, a contractual risk component 620, and risk factor tables 622. The admin component allows an administrator to perform administrative tasks such as adding or deleting users, modifying data in the database, or defining permissions. The web engine receives requests, such as HTTP requests, from user computers and invokes the appropriate component of the contractual risk management system to service the request and provide responses, such as HTTP responses. The input component coordinates the entry of the contract information, risk factor and premise information, and variation information for proposed contracts. The input component stores the data in the database. Each contract may be identified by a unique project identifier. The contractual risk component manages the risk factors, premises, and variations for each proposed contract, as well as approvals or disapprovals of proposed variations. The generate report component compiles the contractual risk data by searching the database and generates the risk reports and other reports for the risk assessment team and management. The user database may contain an entry for each user authorized to use the contractual risk managemnet system. The database may include a user name and password of each user for authentication and authorization purposes. Each user may have different levels of authority. For example, one user may have authority to create a new contract, while another user (e.g., an in-house counsel) may have authority to approve or disapprove for a certain risk factor or premise (e.g., choice of law outside the United States). The risk factor tables may include various tables that identify risk factors and premises and may be substantially similar to Table 1 in one embodiment.

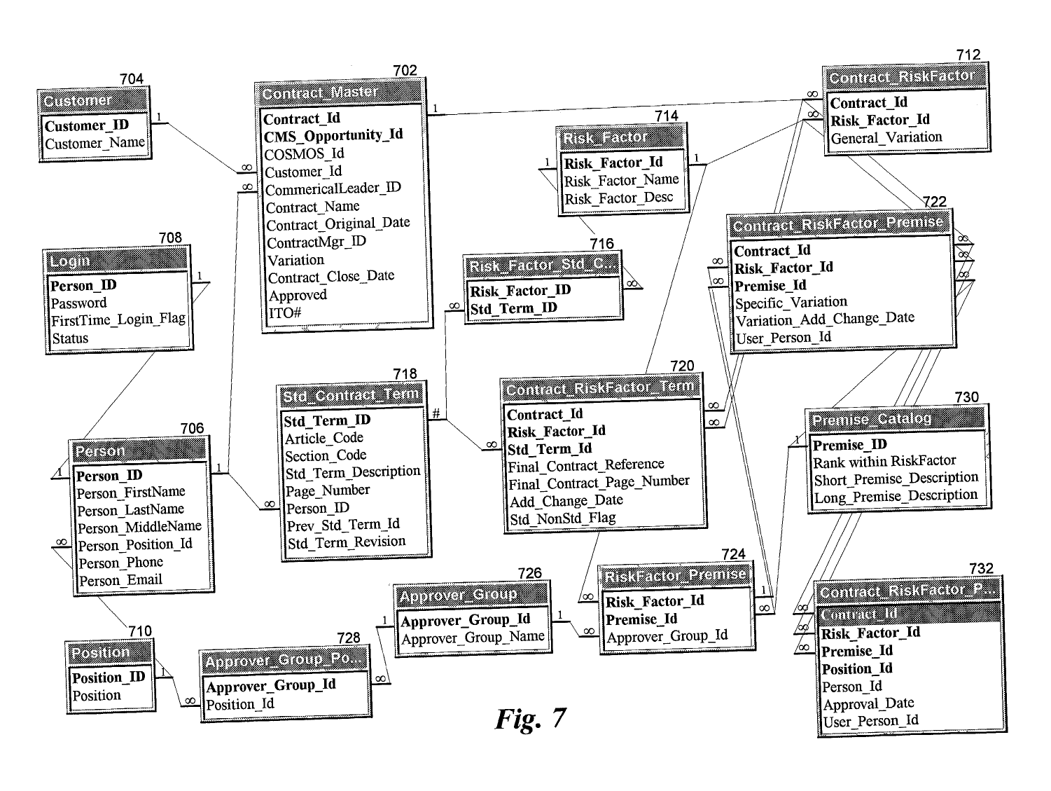

FIG. 7 illustrates a database schema for the contractual risk management system in one embodiment. FIG. 7 includes a number of data structures or tables that represent a relational data model. One skilled in the art would appreciate that the database schema may be organized very differently depending on the design choice of the developers. FIG. 7 only represents one possible logical organization of the contractual risk management sytem. The actual design of the database may take advantage of well-known techniques to meet the speed requirements, response time requirements, and other requirements of a particular implementation of the contractual risk system. In one embodiment, a Microsoft Access or Oracle database may be used. The database schema of FIG. 7 includes a contract_master table 702 with entries that include a contract identification number and a number of entries related to that contract, including a customer identification number, a commercial leader identification, a contract name, a contract original date, a contract manager identification, a variation field, a contract close date, and an approved indication. The contract_master table is linked to a customer table 704 with entries associating customer names with customer identification numbers. The contract_master table is also linked to a person table 706 with entries associating name, position, and contact information with person identification numbers (which may be equivalent to a contract manager identification or commercial leader identification). The person table is linked to a login table 708 with entries containing authorization information such as password, status, and a first time login indicator for each person identification. The person table is also linked to a position table 710 with entries associating position identifications and position names.

The contract_riskfactor table 712 has entries that map a contract to its selected risk factors. Each entry includes a contract identification (from the contract_master table) and a risk factor identification (from the risk_factor table described below). The contract_riskfactor table also includes a general variation field, which includes a general description of the variation typically associated with a risk factor. In an alternative embodiment, the general variation field includes the text description input by a user. The contract_riskfactor table allows each contract identification to have more than one risk factor associated with it by providing multiple entries for each contact. The risk_factor table 714 is linked to the contract_risk factor table and includes an entry for each risk factor. Each entry maps to a risk factor name and a risk factor description. The risk_factor table is also linked to a risk_factor_standard table 716. The risk_factor_standard table associates a risk factor identification with a standard term identification. The standard term identification is an identification of the particular standard term from the standard contract template associated with each risk factor. The risk_factor_standard table is linked to a standard_contract table 718. Each entry in the standard_contract table is associated with a standard term identification. The standard_contract table is similar to a table of contents for the standard contract terms. With each standard term identification there is an article code, a section code, a standard term description, a page number, a person identification (from a link with the person table), a previous standard term identification, and a standard term revision. The article code, section code, and page number identify where in the standard contract the standard term is located, while the standard term description provides a text description of the standard term. The person identification provides the name of the person responsible for the standard term, the previous standard term identification identifies the standard term that the variation is based upon, and the standard term revision indicates the version number of the standard term used as a baseline.

The contract_riskfactor_term table 720 is used to identify the location in contracts where variations are located. Each entry of the contract_riskfactor_term table includes a contract identification, a risk factor identification, and a standard term identification. Each entry of the contract_riskfactor_term table also includes a final reference, a final page number, a change date, and a standard/non-standard flag. The final reference and final page number indicate where in the final contract the variation is located. The change date indicates the date that the variation was last added or changed, and the standard/non-standard flag provides an indication of whether or not standard language was used in the contract.

The contract_riskfactor_premise table 722 maps a contract to its selected risk factors and selected premises. Each entry includes a contract identification, a risk factor identification, and a premise identification. Each entry also includes a specific variation, a variation change date, and a user identification. The specific variation is the text of the specific proposed variation to the standard contract or a description of the text, and the variation change date is the date when the variation was entered into the system. The user identification identifies the person proposing the variation, which may be the contract manager in one embodiment.

The contract_riskfactor_premise table is linked to the riskfactor_premise table 724 that maps risk factors to their premises. Each entry includes a risk factor identification, a premise identification, and an approver group identification. The approver group identification identifies the group necessary to approve a variation for a particular premise and risk factor. The approver_group table 726 has entries mapping approver group identifications and approver group names. The approver_group_position table 728 maps an approver group identification to a position identification. In one alternative embodiment, the approver_group table may be omitted and the riskfactor_premise table and the approver_group_position table are linked directly. The position identification includes a list of positions within an approver group (e.g., Risk/Reward Manager, In House Counsel, etc.). The riskfactor_premise table is also linked to a premise_catalog table 730, which provides a catalog and description for premises. The premise_catalog table entries include a premise identification, a rank, a short description, and a long description. The rank identifies the rank of the premise within the list of premises associated with a particular risk factor. The short and long descriptions provide a summary or detailed description, respectively, of each premise.

The contract_riskfactor_premise table is also linked to a contract_riskfactor_position table 732, where each entry contains a contract identification, a risk factor identification, a premise identification, and a position identification. This table is used to track the approvals that have been received for particular variations in order to create an auditable trail of approvals. The contract_riskfactor_position table also includes a person identification, an approval date, and a user identification. The person identification and user identification provide an identity of the person whose approval was received and the person who entered the information within the system, respectively. The approval date stores the date that the approval information was entered into the contractual risk management system.

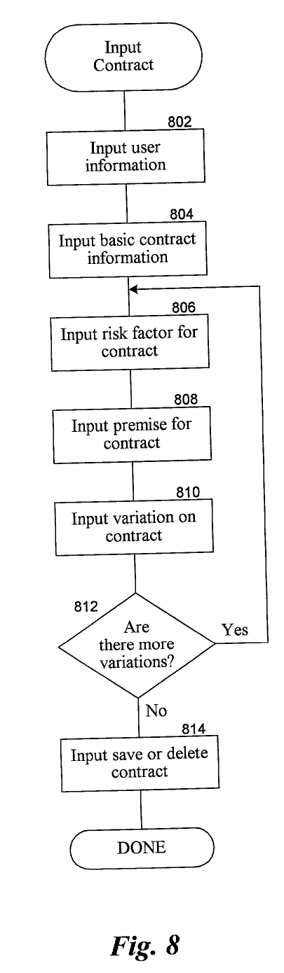

FIGS. 8-13 are flow diagrams illustrating processing of the contractual risk management system in one embodiment. FIG. 8 is flow diagram illustrating a request to input a proposed contract in one embodiment. A user who wishes to enter a proposed contract into the contractual risk management system makes the request in order to seek the necessary approval for any variations from the standard contract, particularly with regard to high risk matters. In block 802, the user inputs user information, which may include a name, a user identification, a password, contact information, etc. In block 804, the user inputs basic information about the contract, which may include a contract name, a contract identification number, a date, a customer identification, a close date, a baseline contract, etc. Alternatively, some or all of the information in these blocks could be automatically entered based on pre-defined criteria. In block 806, the user inputs a risk factor (e.g., choice of law) associated with a proposed variation in the contract. In block 808, the user inputs a premise associated with the risk factor selected in block 806 (e.g., choice of law outside the United States, choice of law in a state besides New York). In block 810, the user inputs the specific variation desired in the proposed contract (e.g., choice of law in the province of British Columbia). In decision block 812, if all variations have been entered, the function continues at block 814; otherwise, the function continues at block 806. This allows the function to partially repeat so that multiple proposed variations may be entered. In block 814, the user inputs a save request or a delete request and the function then completes. The save request saves the inputted proposed contract while the delete request cancels the operation without saving the data.

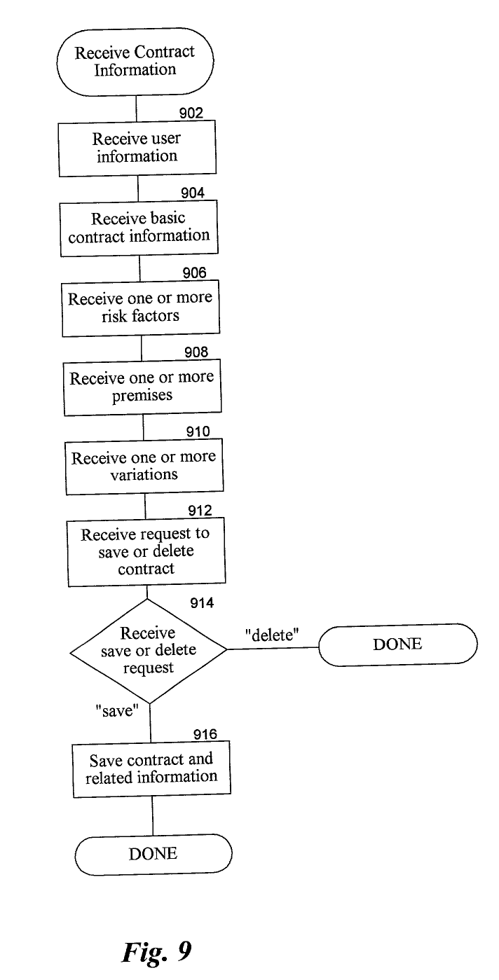

FIG. 9 is a flow diagram illustrating the processing of a request to input a proposed contract by the input component in one embodiment. This function processes the request made by the user to input a proposed contract, as described in relation to FIG. 8. In block 902, the component receives user information and in block 904, the component receives basic contract information. In block 906, the component receives one or more risk factors associated with the proposed contract. In block 908, the component receives one or more premises associated with each risk factor. In block 910, the component receives the actual proposed variations associated with the specified risk factors and premises. In block 912, the component receives a request to save the received information. In one embodiment, the components receives all of the information simultaneously. In block 914, the component saves the contract and related information, which may be stored in a database, and the function then completes.

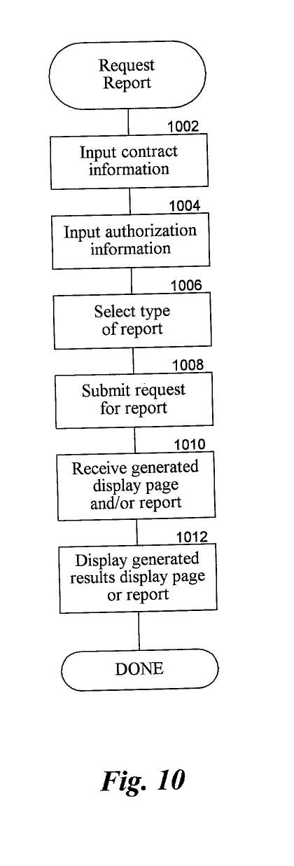

FIG. 10 is a flow diagram illustrating a request for a contractual risk report in one embodiment. The function of FIG. 10 is used when a user who wishes to request a report from the contractual risk management system concerning a particular contract or group of contracts. In block 1002, the user inputs information about the contract, which may include a contract name, a contract identification number, or an indication of a range of contracts. In block 1004, the user optionally inputs authorization information, which may include a user identification and a pasword. In block 1006, the user selects a type of report. One skilled in the art will recognize that many types of reports are possible and within the scope of the invention, including reports concerning the approval status of an individual proposed contract, metrics reports based on different approvals, dates, customer identifications, time to complete approval, geographic region, etc. In block 1008, the user submits the request, which may include the data entered in blocks 1002, 1004, and 1006. In block 1010, the function receives a generated results display page or other embodiment of the complete report. In block 1012, the generated results display page is displayed to the user and the function completes.

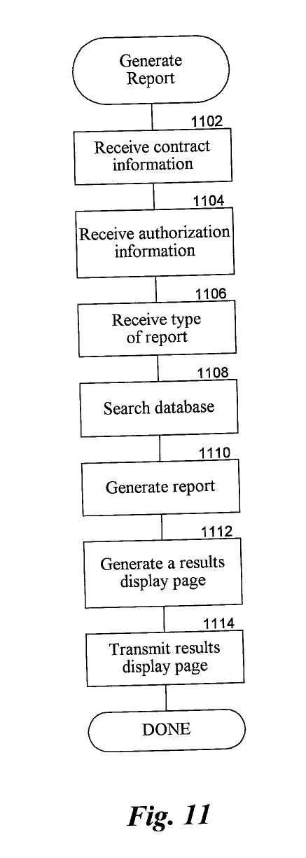

FIG. 11 is a flow diagram illustrating the processing of the generate report component in one embodiment. The generate report component begins processing when a user on a user computer requests a report, as described in relation to FIG. 10, or could begin automatically or at pre-determined times. In block 1102, the component receives contract information from the user and in block 1104, the component optionally receives authorization information from the user. In block 1106, the component receives information about the report desired by the user. In block 1108, the component searches the database based on the contract information and the type of report desired by the user. For example, if the user desired a report about the status of a proposed contract, the component would search the database for all entries related to that proposed contract. In block 1110, the component generates the report based on the information found in the database, and in block 1112 the component generates a results display page. In block 1114, the component transmits the generated results display page to the user computer and the processing of the component completes.

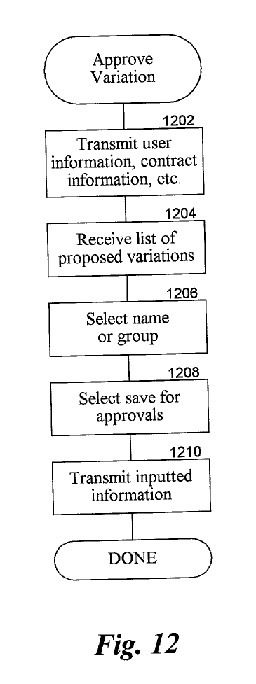

FIG. 12 is a flow diagram illustrating an approval of a variation of a proposed contract in one embodiment. The function of FIG. 12 may be used by a user on a user computer who desires to review the pending approvals related to a proposed contract and to register his or her approval or disapproval of the proposed variations for which he or she has approval authority. In block 1202, the function transmits information to the contractual risk computer, where the information may include user information, authorization information, and information identifying the contract at issue. In block 1204, the function receives a list of proposed risk variations in the contract. These proposed variations may, in one embodiment, be displayed to the user. In another embodiment, only the proposed variations needing approval from the user are received. In block 1206, the user selects their name or organization or provides another indication of their identity and the fact that they want to submit an updated approval status. In block 1208, the user selects a save button, which will register the user's approval of the changes to the contract. In one alternative embodiment, the user may selectively approve only some changes to the contract. In block 1210, the inputted information is transmitted to the contractual risk computer for processing, after which the function ends. The contractual risk computer may update the approval indicator to reflect the new approval (e.g., the contract would then be either “partially approved” or “fully approved”).

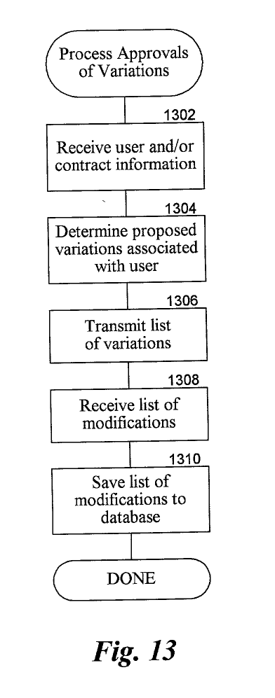

FIG. 13 is a flow diagram illustrating the processing of an approval of a variation of a proposed contract as processed by the contractual risk component in one embodiment. The contractual risk component will process the approval information received from a user as described in relation to FIG. 12. In block 1302, the component receives user information, authorization information, and information identifying the contract at issue from a user on a user computer. In block 1304, the component determines the proposed variations associated with the user, which may require searching the database. In block 1306, the component transmits the list of proposed variations to the user computer. In block 1308, the component receives a list of modifications to the proposed variations (e.g., approval) from the user computer. In block 1310, the component saves the modifications to the database and then completes.

From the above description, it will be appreciated that although specific embodiment of the contractual risk management system have been described for purposes of illustration, various modifications may be made without deviating from the scope of the invention. Accordingly, the invention is not limited except by the following claims.

1. A method in a computer system for managing risk of a contract, the method comprising:
receiving information relating to the contract, the information including one or more risk variations in the contract;
identifying an approver for a variation;
coordinating reception of approval of the variation by the identified approver; and
when all approvals have been received, indicating approval of the contract.

2. The method of claim 1 wherein the identifying includes receiving from a user the identification of an approver.

3. The method of claim 1 wherein at least one risk variation corresponds to a variation from contract risk standards.

4. The method of claim 1 wherein at least one risk variation corresponds to a variation from standard form of contract.

5. The method of claim 1 further comprising identifying contract risk standards established by an organization.

6. The method of claim 1 wherein each risk variation corresponds to one or more risk factors.

7. The method of claim 1 wherein at least one approval is a partial approval.

8. The method of claim 1 wherein at least one approval is conditioned upon changes to the contract.

9. The method of claim 1 further comprising generating a report that summarizes the status of approvals for the proposed contract.

10. The method of claim 1 further comprising generating a report that summarizes the risk variations in the proposed contract.

11. The method of claim 1 further comprising generating a report that summarizes the variations from a standard form of contract.

12. The method of claim 1 further comprising storing the information relating to the contract and an indication of receipt of approval of a risk variation.

13. The method of claim 1 wherein the information relating to the contract includes a contract name, a customer name, an entry date, and a contract close date.

14. The method of claim 1 wherein the contract is a contract for services.

15. The method of claim 1 wherein the contract is a contract for goods.

16. The method of claim 1 wherein the contract is a contract for both goods and services.

17. The method of claim 1 further comprising automatically determining an approver based on the type of risk variation.

18. The method of claim 1 wherein the approver for a risk variation is a group of individuals.

19. The method of claim 1 wherein the approver for a risk variation is an individual.

20. A contractual risk management system comprising:
a receiving means for receiving information related to a contract, wherein the contract information includes an indication of one or more risk variations in the contract;
an identifying means for identifying an approver for a variation;
a coordinating means for coordinating reception of the approval of the variation; and
an approval means for indicating approval of the contract.

21. A contractual risk management system in a risk management computer comprising:
a definition component for receiving information related to a contract from a user on a user computer, the contract information including an indication of one or more risk variations in the contract;
a database for storing the contract information;
a contractual risk component that identifies an approver for at least one risk variation;
a coordination component that coordinates reception of approval of at least one risk variation by the identified approver; and
an indication component that indicates approval of the contract when all required approvals have been received.

22. The system of claim 21 wherein the risk management computer receives from a user the identification of an approver.

23. The system of claim 21 wherein each risk variation corresponds to one or more risk factors.

24. The system of claim 21 wherein the information relating to the contract includes a contract name, a customer name, an entry date, and a contract close date.

25. The system of claim 21 wherein the contract is a contract for servcies.

26. The system of claim 21 wherein the contract is a contract for goods.

27. The system of claim 21 wherein the contract is a contract for both goods and services.

28. The system of claim 21 wherein at least one risk variation corresponds to a variation from contract risk standards.

29. The system of claim 21 wherein at least one risk variation corresponds to a variation from standard form of contract.

30. A computer-readable medium whose contents cause a computer to assist managing risk of a contract by a method comprising: receiving information relating to the contract, the information including one or more risk variations in the contact;
identifying an approver for at least one risk variation;
coordinating reception of approval of at least one risk variation by the identified approver; and
when all approvals have been received, indicating approval of the contract.

31. The computer-readable medium of claim 30 wherein the identifying includes receiving from a user the identification of an approver.

32. The computer-readable medium of claim 30 wherein at least one risk variation corresponds to one or more risk factors.

33. The computer-readable medium of claim 30 wherein at least one risk variation corresponds to a variation from contract risk standards.

34. The computer-readable medium of claim 30 wherein at least one risk variation corresponds to a variation from standard form of contract.

35. The computer-readable medium of claim 30 further comprising generating a report that summarizes the status of approvals for the contract.

36. The computer-readable medium of claim 30 further comprising generating a report that summarizes the risk variations in the proposed contract.

37. The computer-readable medium of claim 30 further comprising generating a report that summarizes the variations from a standard form of contract.

38. The computer-readable medium of claim 30 further comprising storing the information relating to the contract and an indication of receipt of approval of one or more variations.

39. The computer-readable medium of claim 30 wherein the information relating to the contract includes a contract name, a customer name, an entry date, and a contract close date.

40. The computer-readable medium of claim 30 further comprising automatically determining an approver based on the type of variation.

41. The computer-readable medium of claim 30 wherein the approver for a risk variation is a group of individuals.

42. The computer-readable medium of claim 30 wherein the approver for a risk variation is an individual.

43. A method in a user computer for managing risk of a contract, the method comprising:
receiving information relating to the contract, the information including one or more risk variations in the contact;
approving one or more risk variations to the contract, wherein the user has authority to approve at least one risk variation to the contract; and
transmitting an indication of the one or more approved risk variations to a server computer, the server computer being adapted to coordinate the reception of approvals of the variations.

44. The method of claim 43 wherein each variation corresponds to one or more risk factors.

45. A method in a computer system for managing risk of a contract, the method comprising:
receiving information related to the contract, the contract information including an indication of one or more risk variations in the contract;
storing the contract information;
identifying one or more risk factors associated with each risk variation;
identifying one or more premises associated with each risk factor;
receiving a request for a risk report;
generating a risk report, wherein the risk factor report includes at least part of the contract information and an indication of the risk factors and premises associated with the contract; and
transmitting the risk report.

46. The method of claim 45 further comprising providing an indication when all necessary indications of approval are received to approve all variations in the contract.

47. The method of claim 45 wherein the contract information includes a contract name, a contract identification, a customer name, an entry date, and a contract close date.

48. The method of claim 45 further comprising identifying one or more approvers for each variation.

49. The method of claim 45 further comprising determining the one or more risk factors and premises based on the type of variation.

50. The method of claim 45 further comprising determining the one or more risk factors and premises based on the contract information.

51. A computer-readable medium whose contents cause a computer to assist managing risk of a contract by a method comprising:
receiving information related to the contract, the contract information including an indication of one or more risk variations in the contract;
storing the contract information;
identifying one or more risk factors associated with each risk variation;
identifying one or more premises associated with each risk factor;
identifying one or more approvers for each risk variation;
receiving a request for a risk report;
generating a risk report, wherein the risk factor report includes at least part of the contract information and an indication of the risk factors and premises associated with the contract; and
transmitting the risk report.

52. The computer-readable medium of claim 51 further comprising providing an indication when all necessary indications of approval are received to approve all variations in the contract.

53. The computer-readable medium of claim 51 further comprising determining the one or more risk factors and premises based on the type of variation.

54. The computer-readable medium of claim 51 further comprising determining the one or more risk factors and premises based on the contract information.

55. A contractual risk management system comprising:
a receiving means for receiving information related to a contract, the contract information including an indication of one or more risk variations in the contract;
an identiying means for identifying one or more risk factors associated with each risk variation and for identifying one or more premises associated with each risk factor;
a report means for generating a risk report; and
a transmitting means for transmitting the risk report.

56. A contractual risk management system comprising:
a definition component for receiving information related to a contract, the contract information including an indication of one or more variations to the contract;
a database for storing the contract information;
a contractual risk component that identifies one or more risk factors associated with each variation, wherein the contractual risk component also identifies one or more premises associated with each risk factor; and
a risk report component that generates a risk report, wherein the risk report includes at least part of the contract information and an indication of the risk factors and premises associated with the contract.

57. A method in a user computer for managing risk of a contract, the method comprising:
transmitting to a server computer information related to a contract, the contract information including an indication of one or more risk variations in the contract;
wherein the server computer identifies one or more risk factors associated with each risk variation, and wherein further the server computer identifies one or more premises associated with each risk factor; and
receiving a risk report, wherein the risk factor report includes at least part of the contract information and an indication of the risk factors and the premises associated with the contract, and wherein further the risk report includes an indication of the approval status of at least one risk variation, the server computer being adapted to coordinate approvals of the variations.

58. The method of claim 57 further comprising transmitting a request for a risk report to the server computer.

59. The method of claim 57 further comprising transmitting an indication of the risk factors associated with each variation.

60. A computer-readable medium containing a data structure for use by a contractual risk management system, the data structure comprising:
an indication of a contract identification, wherein the contract identification is a contract name or a contract identification number;
an indication of one or more proposed risk variations in the contract associated with the contract identification;
an indication of one or more risk factors associated with each proposed variation.

61. The computer-readable medium of claim 60 further comprising an indication of the approval status of one or more proposed variations.

62. A computer-readable medium containing a data structure for use by a contractual risk management system, the data structure comprising:
an indication of a contract identification, wherein the contract identification is a contract name or a contract identification number; and
an indication of approval of one or more proposed risk variations in the contract.

63. A method in a computer system for managing risk of a contract, the method comprising:
receiving information relating to the contract, the information including one or more risk variations in the contract;
identifying risk guidelines and parameters, the risk guidelines and parameters being associated with an organization and with one or more risk variations;
determining a description for each risk guideline and parameter; and
generating a report summarizing the one or more risk variations in the contract and risk guidelines and parameters associated with the one or more risk variations, the report also describing each risk guideline and parameter included in the report.
